(19) United States
(12) Patent Application Publication
(10) Pub. No.: US 2018/0061287 A1
(43) Pub. Date: Mar. 1, 2018

(54) PORTABLE FLAG POLE

(71) Applicants: Kermit A. Gladfelter, Church Hill, TN (US); Vicki D. Gladfelter, Church Hill, TN (US)

(72) Inventors: Kermit A. Gladfelter, Church Hill, TN (US); Vicki D. Gladfelter, Church Hill, TN (US)

(21) Appl. No.: 15/246,492

(22) Filed: Aug. 24, 2016

(51) Int. Cl. G09F 17/00

(52) U.S. Cl. CPC G09F 17/0091; G09F 2017/0066

(57) ABSTRACT

A portable flag pole is a portable assembly which is able to be assembled with a weighted base, or slid over a stake which is driven into the ground for support; then attach a flag of preference, with the portable assembly keeping the flag pointed in the wind direction to inhibit tangling.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of flag poles and more specifically relates to a portable flag pole having a detachable patio base.

### 2. DESCRIPTION OF THE RELATED ART

A flagpole, flag mast, flagstaff, or staff can be a simple support, made of wood or metal. If it is taller than can be easily reached to raise the flag, a cord is used, looping around a pulley at the top of the pole with the ends tied at the bottom. The flag is fixed to one lower end of the cord, and is then raised by pulling on the other end. The cord is then tightened and tied to the pole at the bottom. The pole is usually topped by a flat plate or ball called a “truck” (originally meant to keep a wooden pole from splitting) or a finial in a more complex shape. Very high flagpoles may require more complex support structures than a simple pole, such as a guyed mast.

Portable flag poles have become popular in more recent years, with a portable assembly, and a simple structure being widely used for the purpose of flying a flag of one's choosing. While the flag is attached to the structure, wind subjects the flag to tangling and wrapping itself around the pole.

Various attempts have been made to solve the above-mentioned problems such as those found in U.S. Pat. No. 6,799,530 to Silas A. Heichelbech; U.S. Pat. No. 5,522,342 to Huang Chen-Chao; and U.S. Publication No. 20130319315 to Wu Tsung-Chen. This art is representative of flag poles. None of the above inventions and patents, taken either singly or in combination, is seen to describe the invention as claimed.

Ideally, a flag pole should provide ease of use and, yet would operate reliably and be manufactured at a modest expense. Thus, a need exists for a reliable portable flag pole to avoid the above-mentioned problems.

### BRIEF SUMMARY OF THE INVENTION

In view of the foregoing disadvantages inherent in the known flag pole art, the present invention provides a novel portable flag pole. The general purpose of the present invention, which will be described subsequently in greater detail is to provide an improved portable flag pole, which keeps the movement of the flag in the wind direction for inhibiting any tangling.

A portable flag pole is disclosed herein, in a preferred embodiment comprising: a detachable patio base which is adapted to be placed upon a supporting surface, a longitudinally extendable rod which is detachably connected to the patio base and extends therefrom, an elbow pipe detachably and movably connected to a distal end of the longitudinally extendable rod, an extendable tubular pipe detachably connected to the elbow pipe, a T-shaped joint detachably connected to a distal end of the extendable tubular pipe, and a flag supporting member including a pair of spaced guides which includes a means for fastening to portions of a flag member.

The flag supporting member is formed as a tubular pipe and releasably connected with the T-shaped joint and is capable of being held at a predetermined angle and rotated 360 degrees via the elbow pipe. The longitudinally extendable rod includes a pointed pin member which has a length of 24 inches and is connected to a proximal end which is capable of being inserted within a hole within a top portion of the patio base. The flag supporting member includes a cap member formed from PVC on each opposite end thereof. The pair of guides includes a spring clip for releasably holding the flag member. The flag pole is made from a material selected from a group of materials consisting of PVC, rigid plastic, synthetic plastic, metal, and non-metallic elements.

A portable flag assembly comprising: a flag member and a portable flag pole having a detachable patio base adapted to be placed upon a supporting surface, a longitudinally extendable rod which is detachably connected to the patio base and extends therefrom, an elbow pipe detachably and movably connected to a distal end of the longitudinally extendable rod, an extendable tubular pipe detachably connected to the elbow pipe, a T-shaped joint detachably connected to a distal end of the extendable tubular pipe, and a flag supporting member including a pair of spaced guides which includes a means for fastening to portions of a flag member.

The flag supporting member is formed as a tubular pipe and releasably connected with the T-shaped joint and is capable of being held at a predetermined angle and rotated 360 degrees via the elbow pipe. The longitudinally extendable rod includes a pointed pin member which has a length of 24 inches and is connected to a proximal end which is capable of being inserted within a hole within a top portion of the patio base. The flag supporting member includes a cap member formed from PVC on each opposite end thereof. The pair of guides includes a spring clip for releasably holding the flag member. The flag pole is made from a material selected from a group of materials consisting of PVC, rigid plastic, synthetic plastic, metal, and non-metallic elements.

The present invention holds significant improvements and serves as a portable flag pole. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, portable flag pole constructed and operative according to the teachings of the present invention.

FIG. 1 shows a perspective view illustrating a portable flag pole according to an embodiment of the present invention.

FIG. 2 is a side view illustrating a portable flag pole according to an embodiment of the present invention of FIG. 1.

FIG. 3 is a perspective view illustrating a portable flag pole in an in-use condition 102 according to an embodiment of the present invention of FIG. 1.

FIG. 4 is another side view illustrating a portable flag pole according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a flag pole and more particularly to a portable flag pole as used to improve the ability of a user to fly a flag at a location of their choosing, and keep the flags movement in the wind direction and inhibits tangling.

Generally speaking, a portable flag pole is a portable assembly which is able to be assembled with a weighted base, or slid over a stake which is driven into the ground for support; then attach a flag of preference, with the portable assembly keeping the flag pointed in the wind direction to inhibit tangling.

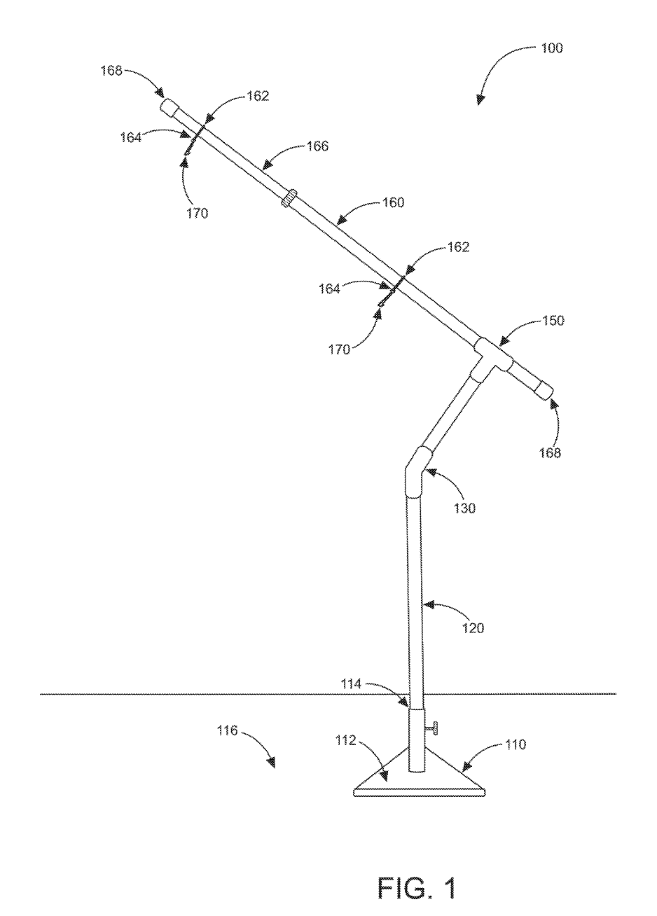

Referring to the drawings by numerals of reference there is shown in FIG. 1, a perspective view illustrating a portable flag pole 100 according to an embodiment of the present invention.

Portable flag pole 100 is disclosed in a preferred embodiment comprising: detachable patio base 110 which is adapted to be placed upon a supporting surface 116, longitudinally extendable rod 120 which is detachably connected to patio base 110 and extends therefrom, elbow pipe 130 detachably and movably connected to distal end of longitudinally extendable rod 120, extendable tubular pipe 140 detachably connected to elbow pipe 130, T-shaped joint 150 detachably connected to a distal end of extendable tubular pipe 140, and flag supporting member 160 including pair of spaced guides 162 which includes a means for fastening 164 to portions of flag member 104.

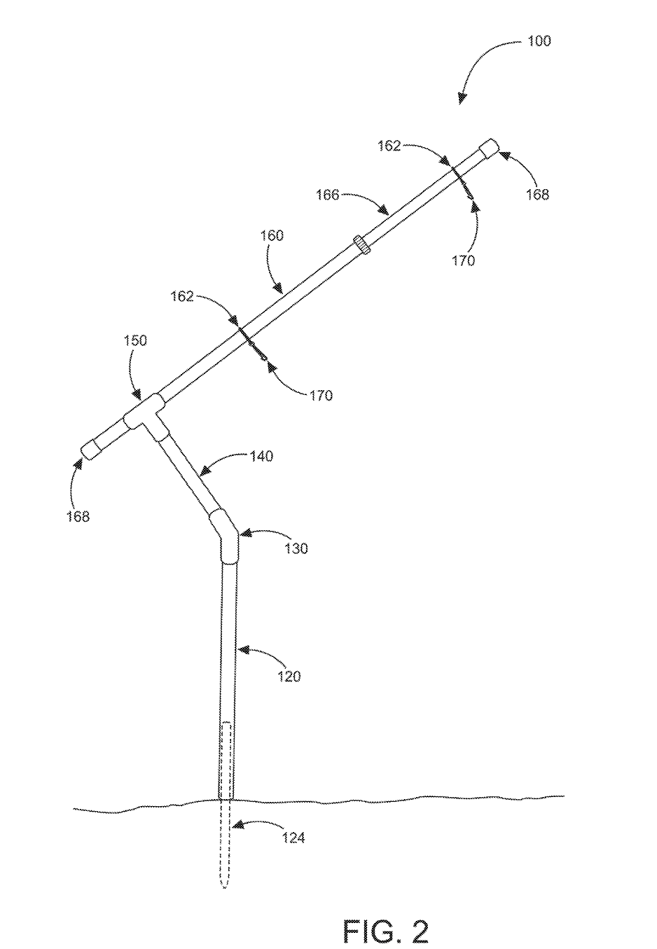

Referring now to FIG. 2, a side view illustrating a portable flag pole 100 according to an embodiment of the present invention.

Flag supporting member 160 is formed as tubular pipe 166 and releasably connected with T-shaped joint 150 and is capable of being held at a predetermined angle and rotated 360 degrees via elbow pipe 130. Longitudinally extendable rod 120 includes pointed pin member 124 which has a length of 24 inches and is connected to a proximal end which is capable of being inserted within hole 114 on top portion of detachable patio base 110. Flag supporting member 160 includes cap member 168 formed from PVC on each opposite end thereof. Pair of spaced guides 162 includes spring clip 170 for releasably holding flag member 104. Portable flag pole 100 is made from a material selected from a group of materials consisting of PVC, rigid plastic, synthetic plastic, metal, and non-metallic elements.

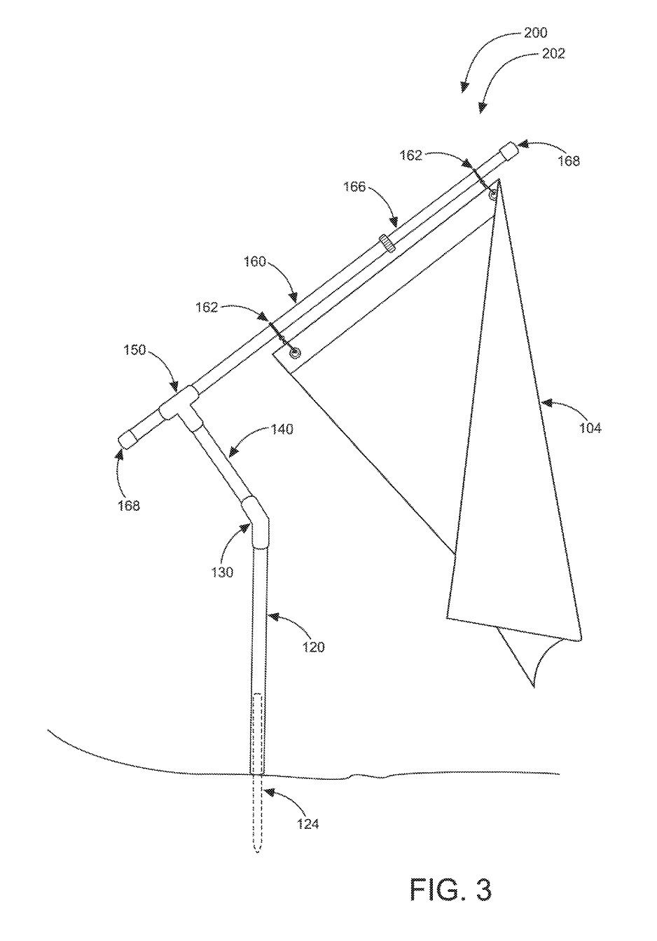

Referring now to FIG. 3, a perspective view illustrating portable flag assembly 200 in an in-use condition 202 according to an embodiment of the present invention.

Portable flag assembly 200 is disclosed comprising: flag member 104 and portable flag pole 100 having detachable patio base 110 adapted to be placed upon a supporting surface 116, longitudinally extendable rod 120 which is detachably connected to detachable patio base 110 and extends therefrom, elbow pipe 130 detachably and movably connected to distal end of longitudinally extendable rod 120, extendable tubular pipe 140 detachably connected to elbow pipe 130, T-shaped joint 150 detachably connected to a distal end of extendable tubular pipe 140, and flag supporting member 160 including pair of spaced guides 162 which includes means for fastening 164 to portions of flag member 104.

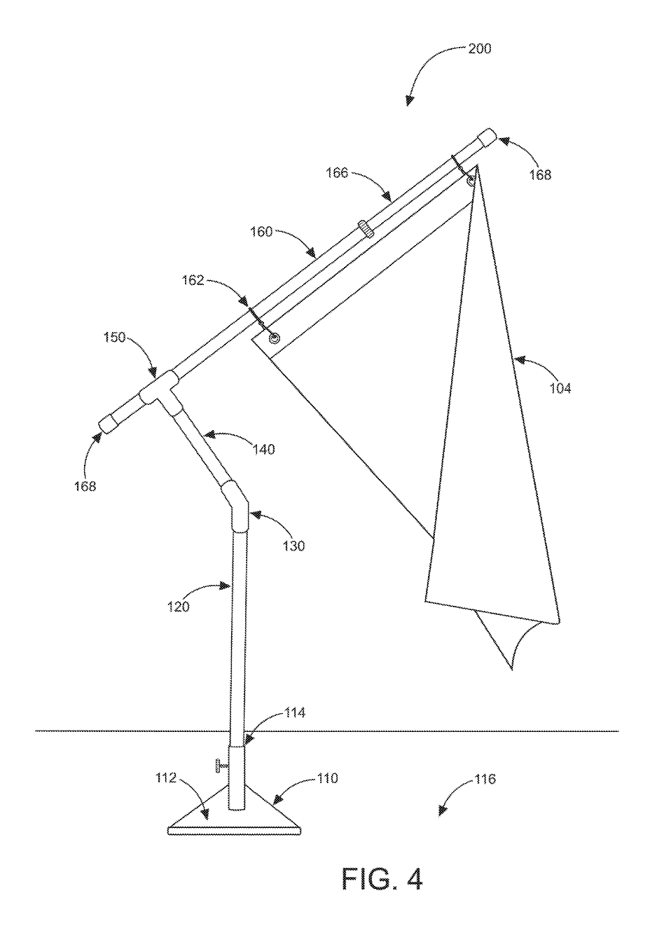

Referring now to FIG. 4, showing another side view illustrating a portable flag assembly 200 according to an embodiment of the present invention.

Flag supporting member 160 is formed as tubular pipe 166 and releasably connected with T-shaped joint 150 and is capable of being held at a predetermined angle and rotated 360 degrees via elbow pipe 130. Longitudinally extendable rod 120 includes pointed pin member 124 which has a length of 24 inches and is connected to a proximal end which is capable of being inserted within hole 114 on top portion of detachable patio base 110. Flag supporting member 160 includes cap member 168 formed from PVC on each opposite end thereof. Pair of spaced guides 162 includes spring clip 170 for releasably holding flag member 104. Portable flag pole 100 is made from a material selected from a group of materials consisting of PVC, rigid plastic, synthetic plastic, metal, and non-metallic elements.

Portable flag pole 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable flag pole comprising:
a detachable patio base;
wherein said patio base is adapted to be placed upon a supporting surface;
a longitudinally extendable rod;
wherein said longitudinally extendable rod detachably connected to said patio base and extends therefrom;
an elbow pipe;
wherein said elbow pipe is detachably and movably connected to a distal end of said longitudinally extendable rod;
an extendable tubular pipe;
wherein said extendable tubular pipe is detachably connected to said elbow pipe;
a T-shaped joint;
wherein said T-shaped joint is detachably connected to a distal end of said extendable tubular pipe; and
a flag supporting member including:
a pair of spaced guides, wherein each guide includes:
a means for fastening adapted to releasably fasten to portions of a flag member;
wherein said flag supporting member is releasably connected with said T-shaped joint;
wherein said flag supporting member is capable of being held at a predetermined angle and rotated 360 degrees via said elbow pipe.

2. The portable flag pole according to claim 1, wherein said longitudinally extendable rod includes a pointed pin member connected to a proximal end thereof and is capable of being inserted within a hole within a top portion of said patio base.

3. The portable flag pole according to claim 2, wherein said pointed pin member has a length of 24 inches.

4. The portable flag pole according to claim 1, wherein said flag supporting member includes a cap member on each opposite end thereof.

5. The portable flag pole according to claim 4, wherein said cap member is formed from PVC.

6. The portable flag pole according to claim 1, wherein each of said pair of guides includes a spring clip for releasably holding said flag member.

7. The portable flag pole according to claim 1, wherein said flag supporting member is formed as a tubular pipe.

8. The portable flag pole according to claim 1, wherein said flag pole is made from a material selected from a group of materials consisting of PVC, rigid plastic, synthetic plastic, metal, and non-metallic elements.

9. A portable flag assembly comprising:
a flag member; and
a portable flag pole comprising;
a detachable patio base;
wherein said patio base is adapted to be placed upon a supporting surface;
a longitudinally extendable rod;
wherein said longitudinally extendable rod detachably connected to said patio base and extends therefrom;
an elbow pipe;
wherein said elbow pipe is detachably and movably connected to a distal end of said longitudinally extendable rod;
an extendable tubular pipe;
wherein said extendable tubular pipe is detachably connected to said elbow pipe;
a T-shaped joint;
wherein said T-shaped joint is detachably connected to a distal end of said extendable tubular pipe; and
a flag supporting member including:
a pair of spaced guides, wherein each guide includes:
a means for fastening adapted to releasably fasten to portions of said flag member;
wherein said flag supporting member is releasably connected with said T-shaped joint;
wherein said flag supporting member is capable of being held at a predetermined angle and rotated 360 degrees via said elbow pipe.

10. The portable flag pole according to claim 1, wherein said longitudinally extendable rod includes a pointed pin member connected to a proximal end thereof and is capable of being inserted within a hole within a top portion of said patio base.

11. The portable flag pole according to claim 2, wherein said pointed pin member has a length of 24 inches.

12. The portable flag pole according to claim 1, wherein said flag supporting member includes a cap member on each opposite end thereof.

13. The portable flag pole according to claim 4, wherein said cap member is formed from PVC.

14. The portable flag pole according to claim 1, wherein each of said pair of guides includes a spring clip for releasably holding said flag member.

15. The portable flag pole according to claim 1, wherein said flag supporting member is formed as a tubular pipe.

16. The portable flag pole according to claim 1, wherein said flag pole is made from a material selected from a group of materials consisting of PVC, rigid plastic, synthetic plastic, metal, and non-metallic elements.
